(19) United States
(12) Patent Application Publication
(10) Pub. No.: US 2015/0158166 A1
(43) Pub. Date: Jun. 11, 2015

(54) Pneumatic Percussion Mechanism Apparatus

(71) Applicant: ROBERT BOSCH GMBH, Stuttgart (DE)

(72) Inventors: Gerd Schlesak, Tamm (DE); Juergen Lennartz, Ostfildern (DE); Christian Bertsch, Markgroeningen (DE); Antoine Vandamme, Gerlingen (DE); Matthias Tauber, Bad Boll (DE)

(73) Assignee: ROBERT BOSCH GMBH, Stuttgart (DE)

(21) Appl. No.: 14/400,426

(22) PCT Filed: Apr. 24, 2013
(86) PCT No.: PCT/EP2013/058442

§ 371 Date: Nov. 11, 2014

(30) Foreign Application Priority Data
May 25, 2012 (DE) 10 2012 208 891.1

(51) Int. Cl. B25D 11/00; B25D 11/02

(52) U.S. Cl. CPC B25D 11/005; B25D 11/02

(57) ABSTRACT

A pneumatic percussion mechanism apparatus, in particular for a rotary and/or percussion hammer, includes a striker mounted so as to be movable in a percussion direction in a guide tube, and at least one venting unit which is configured to influence a movement of the striker. The venting unit has a setting unit configured to set a percussion intensity, and is further configured to influence, during a percussion operation, a venting of a percussion space adjoining the striker in the percussion direction in the guide tube.

### PRIOR ART

There are already known percussion mechanism devices, in particular for rotary and/or percussion hammers, having a striker, and having at least one venting unit that is provided to influence a movement of the striker.

### DISCLOSURE OF THE INVENTION

The invention is based on a pneumatic percussion mechanism device, in particular for a rotary and/or percussion hammer, having a striker, and having at least one venting unit that is provided to influence a movement of the striker.

It is proposed that the venting unit have a setting unit. A pneumatic “percussion mechanism device” in this context is to be understood to mean, in particular, a device provided, at least substantially, to transmit at least one impulse, in particular to an insert tool, preferably in the percussion direction, and to drive the insert tool, preferably in a percussive manner, in at least one operating state. “Provided” is to be understood to mean, in particular, specially designed and/or specially equipped. “At least substantially” in this context is to be understood to mean, in particular, that a deviation from a predefined value is, in particular, less than 25%, preferably less than 10%, and particularly preferably less than 5% of the predefined value. A “striker” in this context is to be understood to mean, in particular, a movably mounted component provided to generate an impulse in the percussion direction as a result of an impact. The striker may generate the percussive impulse as a result of a direct impact upon the insert tool or, preferably, as a result of an impact upon a striking pin. The striking pin may transmit the impulse to the insert tool. The striker may be mounted so as to be movable in the percussion direction, in particular in a guide tube. Preferably, the striker may be accelerated in the percussion direction as a result of pressure being applied on the side of the striker that is opposite to the percussion direction. The application of pressure may be effected as a result of a piston, likewise mounted so as to be movable in the guide tube and disposed on the side of the striker that is opposite to the percussion direction, being moved in the percussion direction. The piston may compress an air volume, constituting a pressure cushion, that is disposed between the piston and the striker and enclosed by the piston and the striker with the guide tube. Pressure may be applied to the striker. A “venting unit” in this context is to be understood to mean a unit provided to vent, at least partially, a pressure cushion adjoining the striker. “Venting” in this context is to be understood to mean an at least partial equalization of an air pressure of a space with an ambient pressure of an environment connected to the space via the venting unit. The venting unit may be provided to vent a compression space. A “compression space” in this context is to be understood to mean, in particular, a space in the guide tube that is delimited by the piston and the striker. Preferably, the venting unit may be provided to vent a percussion space. A “percussion space” in this context is to be understood to mean, in particular, a space in the guide tube that adjoins the striker in the percussion direction. The venting unit may comprise at least one of the guide tube. The venting unit may comprise venting channels. The venting unit may allow escaping air to escape into a space that surrounds the guide tube or adjoins the guide tube, such as a percussion mechanism space and/or, preferably, a transmission space. A “percussion mechanism space” in this context is to be understood to mean, in particular, a space that surrounds the guide tube, at least partially, and that is connected to the percussion space via at least one venting opening of the guide tube. A “transmission space” in this context is to be understood to mean, in particular, a space provided to accommodate devices for driving the percussion mechanism and/or the insert tool, in particular an eccentric gear mechanism and/or a connecting rod for driving the piston of the percussion mechanism device and/or a transmission, in order to transmit a rotational motion to the insert tool. The transmission space may comprise a pressure equalizing unit, which is provided to equalize pressure with an environment of the transmission space. Preferably, the venting unit and/or the pressure equalizing unit may allow air to escape into an environment of the percussion mechanism device, in particular into an environment of a rotary and/or percussion hammer having the percussion mechanism device. “Influence” the movement of the striker in this context is to be understood to mean, in particular, that an acceleration of the striker can be increased and/or reduced by the venting unit. In particular, the venting unit may be provided to reduce a pressure acting upon the striker. A “setting unit” in this context is to be understood to mean a unit of the venting unit that is provided to set an effectiveness of the venting. In particular, the setting unit may be provided to alter a quantity of air that flows through the venting unit as a result of a pressure difference. The setting unit may be settable by a user. Preferably, an adjusting unit that is clearly visible from the outside is provided for adjustment of the setting unit by the user. The adjusting unit may be realized, for example, as a selector wheel and/or as a setting ring. Particularly preferably, the setting unit may be settable by a control unit. A “control unit” in this context is to be understood to mean, in particular, a device that is provided to control, in particular, a drive unit of the pneumatic percussion mechanism and/or the pneumatic percussion mechanism by open-loop and/or closed-loop control. The control unit may preferably be realized as an electrical, in particular as an electronic, control unit. The setting unit may be optimally set by the control unit in dependence on operating parameters. A movement of the striker may be influenced by setting of the setting unit of the venting unit.

It is proposed that the setting unit be provided to set a flow cross section at at least one throttle point of the venting unit. A “throttle point” in this context is to be understood to mean, in particular, a region of an air guide of the venting unit that has a reduced flow cross section. Preferably, the setting unit may be provided to reduce and/or fully close the flow cross section at the at least one throttle point. A simple and efficient setting unit may be constituted. Preferably, the setting unit is provided to set the flow cross sections a plurality of throttle points. Particularly preferably, the setting unit may be provided to fully or partially open and/or close some of the throttle points in a plurality of steps. A particularly well defined setting capability of the setting unit may be achieved.

Further, it is proposed that at least one throttle point be disposed at a transition between a percussion mechanism space and a transmission space. The percussion mechanism space is preferably connected, in respect of pressure, to a percussion space. Preferably, the venting unit, in at least one setting, is provided to vent the percussion space into the transmission space. Preferably, venting openings in the guide tube constitute a transition between the percussion space and the percussion mechanism space. Air guides of the venting unit may preferably be constituted by parts of the transmission housing. Preferably, the transmission housing comprises bearing points for supporting the guide tube. Preferably, gaps between the bearing points constitute air guides. Particularly preferably, the gaps between the bearing points differ in their flow cross section. In particular, gaps having a larger flow cross section may alternate with gaps having a smaller flow cross section. Preferably, the setting unit is provided to close gaps having a larger flow cross section and/or gaps having a smaller flow cross section. The setting unit may wholly or partially close the air guides axially or radially. Preferably, the setting unit may be provided to close the air guides in a stepless manner. It is possible for the setting unit to be set in multiple steps. Preferably, the setting unit may be provided, in at least one setting, to reduce a flow cross section of the throttle points, starting from 100% with fully opened throttle points, to a cross section of 30-50%, preferably 35-45%, particularly preferably 40%+/−1%. It is possible to influence the movement of the striker in an effective manner. Preferably, the setting unit may be provided to reduce the flow cross section in further steps. Preferably, the adjusting unit has catch positions and/or markings that make it easier for the user to set defined setting by means of the catch positions and/or markings.

Further, it is proposed that the setting unit be provided to influence, during a percussion operation, a venting of the space disposed in front of the striker in a percussion direction. A differential pressure between a percussion space and a compression space may be influenced in an effective manner. The differential pressure may assist the return movement of the striker. Further, it is proposed that the setting unit be provided for setting a percussion intensity. A “percussion intensity” in this context is to be understood to mean, in particular, the mean intensity of the percussive impulses exerted upon the striking pin by the striker in percussive operation. In particular, the setting unit, by a reduced venting of the percussion space during a movement of the striker in the percussion direction, may effect a pressure that counteracts the movement of the striker. An acceleration and/or velocity of the striker in the percussion direction may be reduced. The resultant percussive impulse may be reduced. The setting unit, by an increased venting of the percussion space during a movement of the striker in the percussion direction, may reduce a pressure that counteracts the movement of the striker. An acceleration and/or velocity of the striker in the percussion direction may be increased. The resultant percussive impulse may be greater. A drive unit effecting the acceleration in the percussion direction of the striker may be operated at a constant output for differing percussion intensities. Output regulation and/or setting of the percussion mechanism device may be effected by the setting unit of the venting unit. It is possible for a cooling unit, additionally driven by the drive unit, for cooling the drive unit and/or the percussion mechanism device to be unaffected by output regulation and/or setting of the percussion mechanism device.

Further, it is proposed that the setting unit have a setting for fine percussive operation. “Fine percussive operation” in this context is to be understood to mean, in particular, percussive operation with a reduced percussion intensity, preferably with a percussion intensity of less than 50%, and particularly preferably less than 70%, of the percussion intensity in normal percussive operation. “Normal percussive operation” in this context is to be understood to mean, in particular, percussive operation with open throttle points, and/or percussive operation in which a maximum percussion intensity has been set at the setting unit. Preferably, the adjusting unit of the setting unit comprises a catch and/or marking that indicates a setting to the fine percussive operation. The fine percussive operation may be particularly suitable for performing work on delicate materials, in particular tiles. Preferably, the setting unit has settings for further advantageous percussion intensities. Persons skilled in the art will define advantageous percussion intensities for various applications.

Further, it is proposed that the setting unit have at least one setting for operation in the case of a reduced ambient pressure. A reduced ambient pressure in this context is to be understood to mean, in particular, an ambient pressure at high elevation, such as at 2000 m above MSL, preferably over 3000 m above MSL, and particularly preferably over 4000 m above MSL. In the case of a reduced ambient pressure, the output capability of the percussion mechanism device may be increased with a reduced venting of the percussion space. Preferably, the adjusting unit comprises catches and/or markings for settings, in particular for normal percussive operation and/or fine percussive operation for reduced ambient pressure. Preferably, the setting unit, in these settings, effects a greater reduction of flow cross sections of the venting unit than in settings for a normal ambient pressure, in particular an ambient pressure at MSL.

Further, it is proposed that the control unit have an operating condition sensor unit, which is provided to set the setting unit, in at least one operating state, in dependence on operating conditions. An “operating condition sensor unit” in this context is to be understood to mean, in particular, a measuring means provided to sense operating conditions of the percussion mechanism device. “Operating conditions” are to be understood to mean, in particular, physical quantities that exert an influence upon the operation of the percussion mechanism device. Operating conditions may be, in particular, environmental conditions of an environment of the percussion mechanism device, in particular an ambient air pressure and/or a temperature. An “influence” in this context is to be understood to mean, in particular, that an operating behavior of the percussion mechanism device such as, in particular, an efficiency and/or a starting behavior, may change because of the operating conditions. The operating condition sensor unit may comprise one or more sensors. A sensor may be disposed on a circuit board of the control unit. In particular, a pressure sensor for the ambient air pressure may be disposed on a circuit board of the control unit. The sensor arrangement may be particularly inexpensive. A sensor may be disposed on a hand power tool housing, on an inside or outside. The sensor may sense measurement values in a particularly precise manner, inside the hand power tool or outside the hand power tool. Preferably, the pressure sensor may have a temperature sensor for sensing a temperature, in particular a temperature of an environment of the percussion mechanism device. The setting unit may be optimally set for the operating conditions. In particular, in the case of a reduced ambient air pressure, the setting unit may be set such that a venting of the space adjoining the striker in the percussion direction is reduced, and/or the throttle points of the venting unit are closed, at least substantially. An output capability of the percussion mechanism device may be increased in the case of low air pressure. In particular, in the case of a normal ambient air pressure, the setting unit may be set such that a venting of the space adjoining the striker in the percussion direction is particularly high, and/or the throttle points of the venting unit are open, at least substantially. “At least substantially” in this context is to be understood to mean, in particular, more than half open, or closed. An output capability of the percussion mechanism device may be increased in the case of high air pressure. The percussion mechanism device may be operated in a particularly reliable manner. The percussion mechanism device may be operated in a highly effective manner in differing operating conditions.

Further, a hand power tool is proposed, comprising a pneumatic percussion mechanism device that has a venting unit comprising a setting unit. The hand power tool may have the stated advantages of the pneumatic percussion mechanism device.

Further, a method is proposed for operation of a pneumatic percussion mechanism device that has a venting unit comprising a setting unit. The pneumatic percussion mechanism device, in operation, may have the stated advantages.

### DRAWING

Further advantages are given by the following description of the drawing. The drawing shows exemplary embodiments of the invention. The drawing, the description and the claims contain numerous features in combination. Persons skilled in the art will also expediently consider the features individually and combine them to create appropriate further combinations.

In the drawing:

FIG. 1 shows a schematic representation of a portion of a pneumatic percussion mechanism device that has a venting unit comprising a setting unit,

FIG. 2 shows a further schematic representation of the venting unit comprising the setting unit and a setting ring,

FIG. 3 shows a further schematic representation of the venting unit comprising the setting unit and the setting ring,

FIG. 4 shows a family of characteristics, with settings of the setting unit that are dependent on ambient pressure,

FIG. 5 shows a schematic representation of a portion of a pneumatic percussion mechanism device that has a venting unit comprising a setting unit, in a second exemplary embodiment, and

FIG. 6 shows a schematic representation of a portion of a pneumatic percussion mechanism device that has a venting unit comprising a setting unit, in a third exemplary embodiment.

### DESCRIPTION OF THE EXEMPLARY EMBODIMENTS

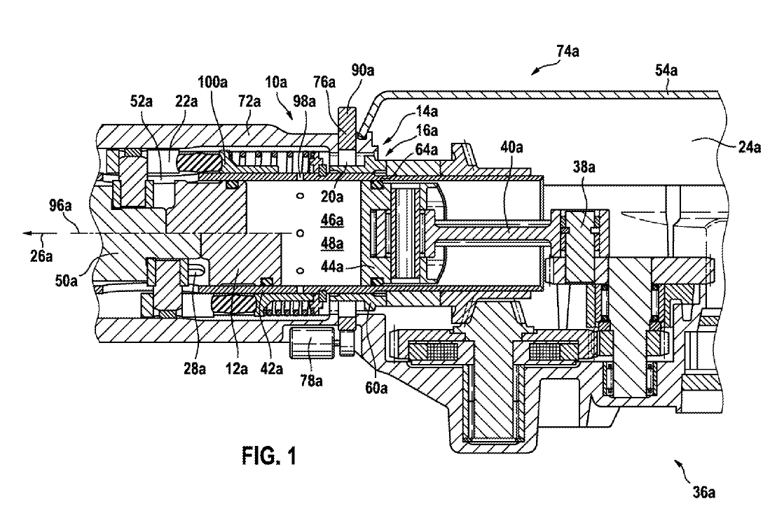

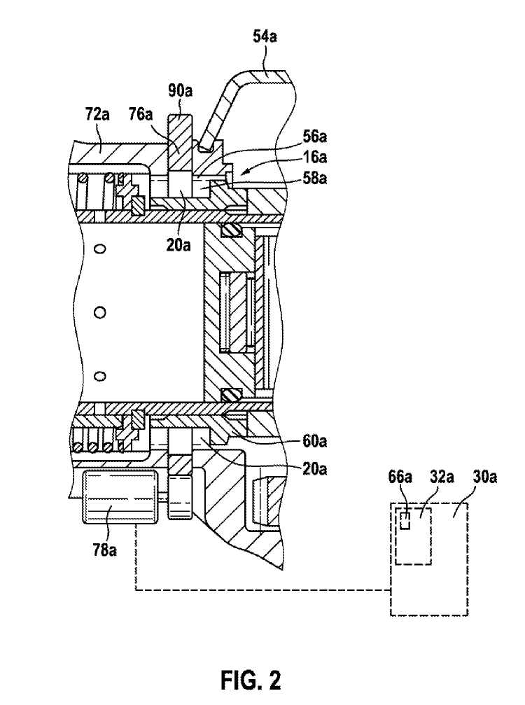

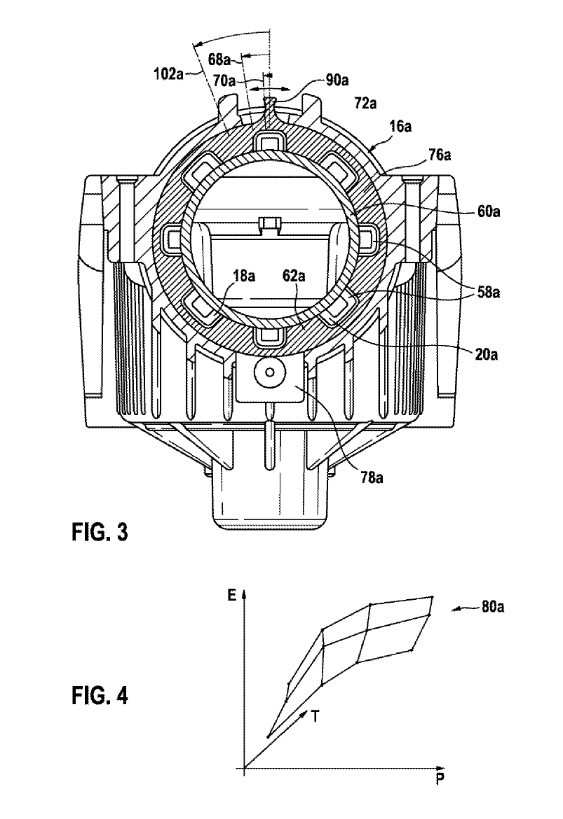

FIG. 1 shows a portion of a pneumatic percussion mechanism device 10a of a rotary and percussion hammer 36a, having a striker 12a, and having a venting unit 14a that is provided to influence a movement of the striker 12a. Such percussion mechanism devices are known to persons skilled in the art. A drive unit, not represented further here, moves a piston 44a, which is guided in a guide tube, periodically back and forth in a percussion direction 26a, by means of an eccentric 38a and a connecting rod 40a. The striker 12a and the piston 44a, with a guide tube 42a, enclose an air cushion 46a in a compression space 48a. The movement of the piston 44a alternately causes a positive pressure and a negative pressure in the pressure cushion 46a, relative to a pressure in a percussion space 28a in the guide tube 42a that is disposed in front of the striker 12a in the percussion direction 26a, which moves the striker 12a alternately in the percussion direction 26a and, in a return movement, contrary to the percussion direction 26a. A striking pin 50a is disposed in front of the striker 12a in the percussion direction 26a. When the striker 12a strikes upon the striking pin 50a, it exerts a percussive impulse that is transmitted from the striking pin 50a to a tool, not represented in greater detail. The percussion mechanism device 10a is represented in an idling mode above a percussion axis 96a, and in a percussion mode below the percussion axis 96a. In the percussion mode, idling openings 98a are closed by a control sleeve 100a. The control sleeve 100a is displaced by the contact pressure of the tool against a workpiece, such that it closes the idling openings 98a. The venting unit 14a has venting openings 52a in the guide tube 42a. The venting openings 52a establish a connection between the percussion space 28a and a percussion mechanism space 22a. The venting unit 14a serves to equalize a pressure of the percussion space 28a with an environment of the percussion mechanism device 10a. The venting unit 14a has a setting unit 16a. The setting unit 16a is provided to influence a venting of the percussion space 28a during a percussion operation. The guide tube 42a of the percussion mechanism device 10a is mounted in a percussion mechanism housing 72a of the rotary and percussion hammer 36a. The percussion mechanism housing 72a has ribs 56a, which are disposed in a star configuration and face toward an outside of the guide tube 42a (FIG. 3). Pressed in between the guide tube 42a and the percussion mechanism housing 72a, in a region 64a that faces toward the eccentric 38a, there is a bearing bush 60a, which supports the guide tube 42a on the percussion mechanism housing 72a. The bearing bush 60a, with the ribs 56a of the percussion mechanism housing 72a, forms air channels 58a that are connected to the venting openings 52a. The air channels 58a constitute a part of the venting unit 14a. Via the air channels 58a, the percussion space 28a is connected to a transmission space 24a, constituted by a transmission housing 54a, that is disposed behind the guide tube 42a against the percussion direction 26a. The transmission housing 54a and the percussion mechanism housing 72a are parts of a hand power tool housing 74a. The air channels 58a constitute throttle points 20a at a transition between the percussion mechanism housing 72a and the transmission housing 54a. The throttle points 20a influence a flow cross section 18a of the connection of the percussion space 28a to the transmission space 24a.

The setting unit 16a has a setting ring 76a, which surrounds the bearing bush 60a. The setting unit 16a is provided to set the flow cross section 18a of the throttle points 20a. The setting ring 76a has valve extensions 62a, which are directed inward in a star configuration. Depending on a rotary position of the setting ring 76a, the valve extensions 62a may wholly or partially overlap the air channels 58a. The flow cross section 18a can be set by adjustment of the setting ring 76a. The user can turn the setting ring 76a at a grip element 90a. The user can thus adjust the setting ring 76a, and consequently the setting unit 16a. In particular, by adjusting the setting ring 76a, the user can partially close the throttle points 20a and thus generate a counter-pressure that brakes the striker 12a in a movement in the percussion direction 26a. The user is able to adjust a percussion intensity. The setting ring 76a comprises a setting 68a for fine percussive operation. In this setting, the flow cross section 18a of the throttle points 20a is reduced by 60%. The percussion intensity is reduced to a fine percussion intensity, which is suitable for performing work on tiles. The setting ring 76a additionally comprises a setting 70a for a reduced ambient pressure. In this setting, the flow cross section 18a of the throttle points 20a is reduced by 20%. The output capability of the percussion mechanism device 10 is increased, with a reduced air pressure. The setting ring 76a additionally comprises a setting 102a in which the throttle points 20a are fully closed. The settings 68a, 70a, 102a are realized as markings. Moreover, a servo drive 78a is disposed on the setting ring 76a. In an automatic operating mode for the setting unit 16a, a control unit 30a can adjust the setting ring 76a by means of the servo drive 78a. A family of characteristics 80a is stored on the control unit 30a. An operating condition sensor unit 32b comprises an ambient pressure sensor 66a for measuring an ambient pressure P and an ambient temperature T. The family of characteristics 80a includes advantageous settings E of the setting unit 16a in dependence on the ambient pressure P and the temperature T. The control unit 30a sets the setting unit 16a to the advantageous settings in dependence on the ambient pressure P and the temperature T. In particular, in the case of a low ambient pressure P, the flow cross section 18a at the throttle points 20a is reduced. The advantageous settings may be defined by persons skilled in the art by means of a simulation or trials. The user may additionally preselect fine percussive operation, via an operating unit, not represented here, of the control unit 30a. For fine percussive operation, the control unit 30a sets the setting unit 16a in dependence on temperature T and ambient pressure P.

The following description and the drawings of further exemplary embodiments are limited substantially to the differences between the exemplary embodiments and, in principle, reference may also be made to the drawings and/or the description of the other exemplary embodiment in respect of components having the same designation, in particular in respect of components having the same reference numerals. To differentiate the exemplary embodiments, the letters b and c have been appended to the references of the further exemplary embodiments, instead of the letter a of the first exemplary embodiment.

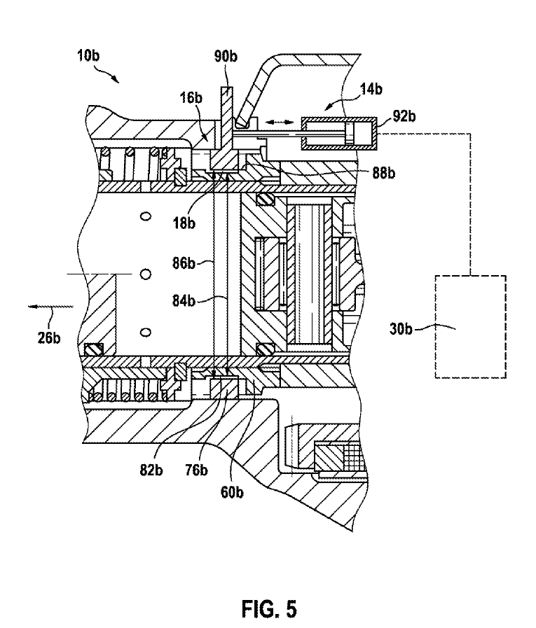

FIG. 5 shows a portion of a venting unit 14b of a pneumatic percussion mechanism device 10b having a setting unit 16b, in a second exemplary embodiment. The second exemplary embodiment differs from the first, in particular, in that a setting ring 76b is mounted on the bearing bush 60b so as to be axially displaceable in a percussion direction 26b. The bearing bush 60b comprises a valve recess 82b, which has an external diameter 84b that is smaller than an internal diameter 86b of the setting ring 76b. If the setting ring 76b is displaced over the valve recess 82b, a distance between the setting ring 76b and the bearing bush 60b forms a flow cross section 18b of the venting unit 14b. In a sealing region 88b, the internal diameter 86b of the bearing bush 60b forms a seal with the setting ring 76b. The venting unit 14b can be set by displacement of the setting ring 76b. The setting ring 76b can be set by a user, via a grip element 90b, or by a linear actuator 92b operated by a control unit 30b.

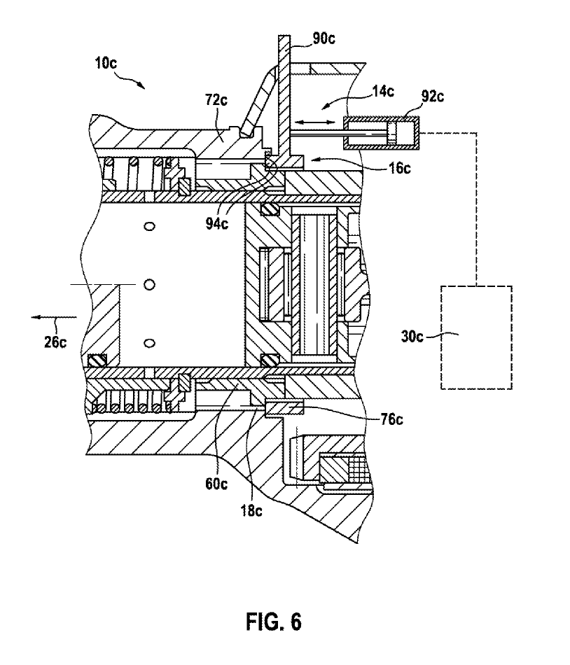

FIG. 6 shows a portion of a venting unit 14c of a pneumatic percussion mechanism device 10c having a setting unit 16c, in a third exemplary embodiment. The third exemplary embodiment differs from the second, in particular, in that a setting ring 76c, mounted so as to be axially displaceable in a percussion direction 26c, is provided to close, depending on its position, a flow cross section 18c between a bearing bush 60c and a percussion mechanism housing 72c. If the setting ring 76c is moved away from the bearing bush 60c, contrary to the percussion direction 26c, it releases the flow cross section 18c. If it is moved against sealing faces 94c of the bearing bush 60c and of the percussion mechanism housing 72c, it closes the flow cross section 18c. The venting unit 14c can thus be set by displacement of the setting ring 76c. The setting ring 76c can be set by a user, via a grip element 90c, or by a linear actuator 92c operated by a control unit 30c.

1. A pneumatic percussion mechanism, comprising:
a striker mounted so as to be movable in a percussion direction in a guide tube, and
at least one venting unit that is configured to influence a movement of the striker, the at least one venting unit including a setting unit configured to:
set a percussion intensity, and
influence, during a percussion operation, a venting of a percussion space adjoining the striker in the percussion direction in the guide tube.

2. The pneumatic percussion mechanism as claimed in claim 1, wherein the setting unit is further configured to set a flow cross section at at least one throttle point of the at least one venting unit.

3. The pneumatic percussion mechanism as claimed in claim 2, further comprising at least one throttle point located at a transition between a percussion mechanism space and a transmission space.

4. The pneumatic percussion mechanism as claimed in claim 1, wherein the setting unit has a fine percussive operation setting.

5. The pneumatic percussion mechanism as claimed in claim 1, wherein the setting unit has at least one setting configured for operation in a reduced ambient pressure.

6. The pneumatic percussion mechanism as claimed in claim 1, further comprising a control unit having an operating condition sensor unit, the control unit configured to set the setting unit, in at least one operating state, with reference to operating conditions.

7. A hand power tool, comprising a pneumatic percussion mechanism that includes:
a striker mounted so as to be movable in a percussion direction in a guide tube; and
at least one venting unit that is configured to influence a movement of the striker, the at least one venting unit including a setting unit configured to:
set a percussion intensity, and
influence, during a percussion operation, a venting of a percussion space adjoining the striker in the percussion direction in the guide tube.

8. A method of operating a pneumatic percussion mechanism, comprising
driving a movement of a striker mounted so as to be movable in a percussion direction in a guide tube; and
influencing the movement of the striker with at least one venting unit, wherein influencing the movement includes:
setting a percussion intensity via a setting unit of the at least one venting unit; and
influencing, during a percussion operation, a venting of a percussion space adjoining the striker in the percussion direction in the guide tube, via the setting unit.
